(19) United States
(12) Patent Application Publication
(10) Pub. No.: US 2006/0114122 A1
(43) Pub. Date: Jun. 1, 2006

(54) Power line inspection vehicle

(76) Inventor: David Iuean Jones, Wales (GB)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/554,483

(22) PCT Filed: Apr. 30, 2004
(86) PCT No.: PCT/GB04/01874

§ 371 Date: Jan. 19, 2006

(30) Foreign Application Priority Data
May 15, 2003 (GB) GB0311138.2

(51) Int. Cl. H04Q 9/00

(52) U.S. Cl. 340/870.07

(57) ABSTRACT

The invention provides a power line inspection apparatus comprising a vehicle body to which is mounted a power line traversal means, a power line inspection means to draw power from a power line to which it is attached, in use.

### FIELD OF THE INVENTION

This invention relates to power lines inspection apparatus and to methods of inspecting power lines.

### BACKGROUND TO THE INVENTION

In many countries, there are extensive networks of kilometres of electricity power lines, suspended overhead in between electricity pylons and the like.

Periodic inspection of each and every power line is necessary in order to ensure that the power lines function correctly and to limit the danger that a power line may break or snap.

In many cases, frequent inspections of power lines is needed, especially after strong weather such as high winds or electrical storms, and the data revealed needs to be of a high quality in order to detect even minor defects in the power lines.

Various attempts have been made to produce an inspection robot, which travels on wheels, rollers or tracks and which is supported by the overhead power lines. Examples of wheeled inspection robots are the EPRI Tomcat (RTM), the Robhot (RTM) for inspecting joints in transmission lines and the Tepco (RTM) robot.

Wheeled robots are adequate for inspecting stretches of power lines between pylons, but have the disadvantage that in order for the robot to traverse any obstacles in the power line path, the robot must effect some sort of movement around or over the obstacle. For example, on pylons, in-line insulators may protrude upwardly and to the side of each electricity power line. Also spur lines may extend at right angles from the pylons onto which the inspection robots may need to drop.

Attempts that have been made include apparatus to traverse obstacles in the path of the power lines, but each of these still relies in some manner on wheel traction to roll the robot along the lines. The Tepco (RTM) robot attempts to traverse obstacles by means of a foldaway guiderail, which lifts the robot over the obstacle. The Robhot (RTM) traverses obstacles by means of a manned helicopter, which lifts it from one area of power line to another over or around an obstacle. The more autonomous EPRI (RTM) and Tepco (RTM) robots employ elaborate mechanical linkages to bypass pylons and obstacles which linkages have not entirely overcome the problem, and tend to increase construction costs, and maintenance costs, and time.

On the other hand, flying inspection robots have also been developed which are independent of such obstacles on the power lines and have the potential to avoid unexpected obstacles, such as tree branches overhanging onto the line which can be a common occurrence and are a major cause of defects in power lines during storms.

Apparatus originally proposed for this role include the Sprite (RTM) which like the majority of other rotor powered vehicles is a remotely piloted vehicle (RPV) piloted via radio link and powered by its own internal 5 KW piston engines.

A key problem in employing remotely piloted rotor powered vehicles, which are arranged to hover and move remote from the power lines is the need to satisfy the “see and avoid” principle for aircraft in unmanaged air space. In many countries there are regulations determining size of a vehicle above which the vehicle becomes an aircraft, or which determines an altitude above which a vehicle flying becomes an aircraft. In the United Kingdom, the Civil Aviation Authority (CAA) rules determine that an air vehicle weighing less than 20 kilograms is a “small” aircraft. An aircraft weighing more than 20 kilograms must comply with the Air Navigation Order (ANO), which includes holding a certificate of airworthiness and obeying the rules of the air. Even if an aircraft weighs less than 20 kilograms, it would not be allowed to fly for aerial work (commercial) purposes other than under the terms of permission issued by the Civil Aviation Authority. In order to be granted permission, it is normally necessary for a remotely piloted vehicle to have checks which do not allow it to fly beyond visual range of the operator, normally deemed to be a distance not exceeding 1500 metres. For a power line inspection to be commercially viable, it may be necessary to have a range of operation of 10-15 kilometres from the operator.

Furthermore, there are rules in many countries as to the altitude to which a vehicle may climb before it is considered a hazard to other air traffic.

Attempts to overcome these difficulties included the provision of rotor powered line inspection apparatus, which include their own power source and are able to traverse power lines on or in the region of the power lines in order to inspect them. These rotor powered inspection robots include a tether line which may be used in conjunction with increased rotor power to lift the robot off the power lines in order to traverse obstacles, but prevent the robot from attaining too high an altitude. Examples of known robots are the Moller Airobots. Problems with such vehicles include a limited operational span due to the finite power source on board the vehicle and the need to remove the inspection robot each time the power source needs to be regenerated or replaced. Furthermore, due to the imposition of a tether line, a operator needs to be reasonably close to the vehicle in order to control the vehicle direction and altitude, and this falls far short of enabling the 10-15 kilometres remote operation needed for a commercially viable inspection vehicle.

It would therefore be advantageous to be able to provide a power line inspection apparatus which could traverse power lines on or in the vicinity of power lines, and in which the apparatus may draw power from the lines themselves such that the operation range of the apparatus is not limited by any particular power source.

It would be further advantageous to provide a power line apparatus which could traverse obstacles in the path of the apparatus whilst being limited to a particular parameter such as altitude, range and the like in order to comply with aviation regulations in a particular location. It would be advantageous to provide a power line inspection apparatus in which a power source within the apparatus can be continually re-charged such that the apparatus may use a power source when remote from power lines, and upon contacting said power lines a subsequent time re-charge the power source to replenish the power that had been used for remote locomotion.

It would be advantageous to provide a power line inspection apparatus which does not include a tether line and which does not rely solely on locomotion remote from power lines in the form of an aircraft or helicopter.

It is therefore an aim of preferred embodiments of the present invention to overcome or mitigate at least one problem of the prior art, whether expressly disclosed herein or not.

### SUMMARY OF THE INVENTION

According to a first aspect of the invention there is provided a power line inspection apparatus comprising a vehicle body to which is mounted a power line traversal means, a power line inspection means and means to draw power from a power line to which it is attached, in use.

Preferably the power line traversal means comprises a locomotion means arranged in use to effect locomotion of the apparatus on or in the region of the power lines to which it is attached.

The locomotion means may comprise wheeled means, or roller means, arranged to contact the power lines and effect movement of the apparatus therealong.

Preferably, however, the locomotion means comprises at least one rotor, and more preferably two or more rotors. Suitably there are two contra-rotating, preferably superposed, rotors, which provide increased rotor efficiency and eliminates the need for a separate tail rotor distal to the primary rotor. Preferably the contra-rotating rotors are in a ducted fan or shrouded fan configuration, more preferably a ducted fan configuration.

The power line inspection means may comprise any suitable means to inspect the condition and integrity of the power line.

The power line inspection means may comprise a camera, preferably a video camera. The power line inspection means may comprise one or more power line characteristic sensors, preferably selected from a current sensor, a voltage sensor, a power line dimension sensor, a power line topology sensor, a thermal sensor (infra-red), or a corona discharge sensor. Preferably however the power line inspection means comprises a camera.

The means to draw power from the power line may comprise means to induce current from the power line, such as a current transformer, for example.

However, preferably the means to draw power from the power line comprises an ohmic contact means, such as a pantograph, for example. Many power transmission systems comprise two or more power lines and preferably the means to draw power from the power line comprises means to draw from all power lines in a power transmission system. A pantograph is particularly useful as a means to draw power from a plurality of power lines as the pantograph effects contact with each of the power lines at all times, and self-corrects if the line inspection apparatus pitches, yaws or rolls on the power line due to the orientation of the lines.

Preferably the pantograph comprises means to bias the pantograph onto the or each power line when the apparatus is connected to the or each line.

The biasing means may comprise a resilient biasing means, such as a spring, for example, but preferably comprises an actuator or servo which effects a force on the pantograph to effect constant contact with a power line to which it connects. The actuator or servo preferably comprises force and position transducers which monitor the force and position of the pantograph actuator or servo and effects adjustment of the pantograph to remain in contact with the or each of the power lines, whatever the positioning of the apparatus on the line, or lines.

At various points along a power transmission system, such as overhead electricity lines, the power lines are routed through a structural element such as pylons, which may include protruding elements and obstacles such as insulators and power line direction routers. These protruding elements will be in the direct path of an apparatus travelling along the power line across the pylon.

For the above reason and other reasons, it is preferable that the power line inspection apparatus further comprises means to circumnavigate obstacles on or in the region of the power lines. The power line inspection apparatus preferably comprises flight means or remote travel means, arranged in use to enable the apparatus to be disconnected from a power line to which it is attached and travel remote from the power line, in order for example to avoid obstacles on or in the region of the power line.

The remote travel means may comprise means able to effect hovering or flight of the apparatus above the power line. The remote travel means may comprise the power line locomotion means, for example, if the power line locomotion means comprises one or more rotors.

Preferably the apparatus comprises means to effect cessation of power take-up from a power line, in order that the apparatus may effect use of the remote travel means. Thus, preferably the apparatus comprises a power storage means, in which power is stored, and such that power can be utilised by the remote travel means when the apparatus is remote from a power line.

The power storage means preferably comprises a power cell or battery. The power cell or battery may be of a disposable type, but is preferably a rechargeable battery or power cell. Preferably the power cell or battery comprises means to recharge via power uptake from a power line to which the apparatus is attached, in use. Preferably the power cell comprises enough power to provide the remote travel means with enough power to effect remote travel within 1 mile of the power line, more preferably within 2 miles of the power line, most preferably within three miles of the power line, for a period of time of no less than 1 minute, preferably no less than 2 minutes, more preferably no less than 5 minutes, and most preferably no less than 10 minutes.

Suitable batteries include lithium batteries, such as the Avestor(RTM) lithium metal polymer battery, supplied by Avestor, Quebec, Canada.

Preferably the apparatus comprises a path obstacle sensor, arranged in use to detect obstacles in the path of the apparatus, on or in the vicinity of the power line.

Preferably the apparatus comprises an apparatus orientation means, which may comprise means for the device to detect its orientation with respect to a power line which it is desired to inspect. Thus the apparatus orientation means may comprise one or more sensors selected from a movement direction sensor, an altitude sensor, a pitch sensor, a roll sensor, a yaw sensor, a speed sensor, a path obstacle sensor, and the like for example. Preferably the apparatus orientation means comprises two or more sensors, at least one of which is a path obstacle sensor arranged in use to detect obstacles in the path of the apparatus on, or in the vicinity of the power line.

Thus the path obstacle sensor may detect when a pylon is near, when insulators are protruding above the plane of the power lines, and/or when the power line drops in height at a junction on a pylon, for example.

Suitably the apparatus comprises movement adjustment means, arranged in use to adjust the movement of the apparatus when an obstacle is detected on the power line in the vicinity of the apparatus. The movement adjustment means may comprise means to effect activation of the remote travel means, if for example an obstacle is detected, which the apparatus cannot traverse, on the power line. The movement adjustment means may comprise means to enable adjustment of the pitch, roll, yaw, height and/or direction of the apparatus, for example in response to variation in the direction of the (or a region of the) power line on which the apparatus is travelling. The movement adjustment means may include the remote travel activation means and may comprise any further suitable means.

The apparatus may comprise altitude limiting means, arranged in use to limit the altitude to which the apparatus can ascend remote from the or each power line. The altitude limiting means may comprise an altitude sensor which, upon the apparatus reaching a defined altitude, cause cessation of power to the apparatus, or which causes movement of the apparatus to a lower altitude. The altitude limiting means is preferably such that a maximum altitude may be set, above which the apparatus cannot ascend.

The maximum altitude will depend on the application and may depend on the local or regional aviation legislation in the area where the apparatus is to be used. For example, it is preferred that the maximum altitude of the apparatus is that above which the apparatus would fall under the definition of an aircraft in a particular location. In many embodiments the maximum altitude is preferably no more than 80 m, more preferably no more than 50 m and most preferably no more than 40 m, above ground level.

### BRIEF DESCRIPTION OF THE DRAWINGS

For a better understanding of the invention and to show how the embodiments of the same may be put into effect the various aspects of the invention will now be described by way of example only in which:

FIG. 1 illustrates a perspective view of a first embodiment of a power line inspection apparatus of the invention located on a three-phase power line;

FIG. 2 illustrates a close up perspective view of a means to draw power from the power lines, of the apparatus of FIG. 1;

FIG. 2A illustrates a side close-up view of the means to draw power shown in FIG. 2;

FIG. 2B illustrates a front close-up view of the means to draw power shown in FIG. 2

FIG. 2C illustrates a side sectional view of the apparatus of FIG. 1 in which the apparatus body has pitched forward;

FIG. 2D illustrates a side sectional view of the apparatus of FIG. 1 in which the apparatus body has lowered in height compared to that in FIG. 2C;

FIG. 3 illustrates part of a electricity pylon comprising a three-phase overhead power line from which a three-phase branch line extends towards the upper right corner of the Figure.

FIG. 4 illustrates a block diagram of the power take-up system of the apparatus of FIG. 1; and

FIG. 5 illustrates a block diagram of a control system used in the apparatus of FIG. 1.

### DESCRIPTION OF THE PREFERRED EMBODIMENT

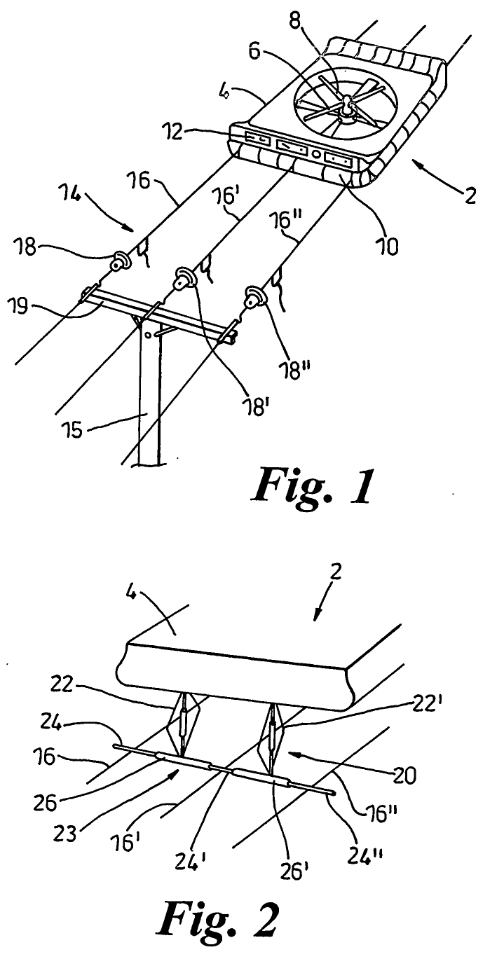

We refer firstly to FIG. 1 which illustrates a perspective view of a power line inspection apparatus of the present invention. The power line inspection apparatus 2 comprises a apparatus body 4 comprising an aperture therethrough, housing a power line traversal means in the form of contra-rotating superposed rotors 6 and 8.

Beneath the apparatus body 4 is an insulating-skirt 10, arranged in use to be located above the power lines to be inspected. At the front of the apparatus body 4 is a bank of power line inspection means (which also function as a path obstacle sensor) comprising video surveillance cameras 12. The body 4 also includes power line inspection means at the rear of the body (not shown) such that the apparatus 2 may inspect power lines in forward and reverse movement modes. The surveillance cameras 12 are arranged at the front of the apparatus body 4 such that during locomotion of the apparatus 2 the surveillance cameras 12 view power lines in front of the apparatus 2. The rotors 6,8 also function as a remote travel means, able to affect hovering and flight of the apparatus 2 above the power lines when required.

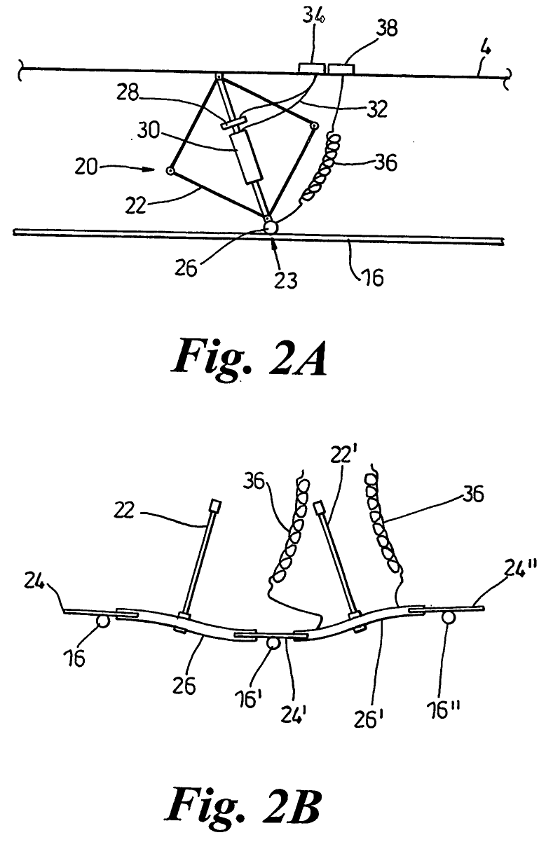

The apparatus further comprises means to draw power from the lines to which the apparatus 2 is attached in the form of an ohmic contact pantograph 20 as shown in FIGS. 2A and 2B. The pantograph 20 is located beneath the apparatus body 4 extending downwardly therefrom. The pantograph 20 is arranged in use to contact the or each power line to which the apparatus 2 is attached. The pantograph 20 of FIG. 2 of the embodiment shown in FIG. 1 comprises an ohmic contact bar comprising an elongated bar which includes two insulating areas 26, 26′ separating three power uptake regions arranged 24, 24′, 24″ to draw power from a three phase, three line electricity overhead cable. The pantograph 20 further includes movement-compensating means in the form of adjustable frames 22, 22′ extending from the insulating portions 26, 26′ of the contact bar 24, and connecting to the underside of the apparatus body 4. The frames 22, 22′ are servo controlled. As shown in FIGS. 2A and 2B the pantograph frames 22, 22′ include movement means in the form of a load cell 28 and linear actuator 30, connected to a digital controller 34 by way of control lines 32.

The contact bar 23 is connected to a transformer 38 by way of a high tension (HT) umbilical cord 36.

The apparatus 2 comprises within the body 4 a power storage means (not shown) in the form of rechargeable Avestor(RTM) lithium metal polymer battery which allows cessation of power take up from a power line in order that the apparatus may effect use of the remote travel means (rotors 6,8), by enabling power to be supplied to the rotors when power take up is switched off from the power lines 16, 16′, 16″.

Use of the apparatus 2 shown in FIGS. 1,2 and 2A to 2D will now be described with reference to said Figures.

We refer firstly to FIG. 1. Part of FIG. 1 illustrates a three phase power line system 14 which includes three power lines 16, 16′ and 16″ extending spaced apart and parallel with each other. The power lines are suspended above the ground by a pylon 15 comprising a cross bar 19 extending perpendicular there from at the top of the pylon 15. The power lines 16, 16′ and 16″ traverse the cross bar 19 and are held up at the point of contact between the power lines and the cross bar 19. On one side of the power lines 16, 16′ and 16″ are insulators 18, 18′ and 18″ in the form of substantially circular insulator members. The insulators 18, 18′ and 18″ are obstacles over which an apparatus for inspecting power lines must pass in order to traverse the entire length of the power lines.

The power line inspection apparatus 2 shown in FIG. 1 is lowered onto the power line system 14 via any suitable means such as under its own auxiliary battery power or via a transport heli-vehicle, which may be piloted or a remotely piloted heli-vehicle, or a jib-hoist on a ground vehicle, for example.

The apparatus 2 is lowered onto the power line system 14 such that the apparatus body 4 traverses all three power lines 16,16′ and 16″. As shown in FIG. 2, as the apparatus 2 is lowered onto the power lines 16, 16′ and 16″, the pantograph 20 is arranged such that the ohmic contact bar 23 contacts each of the power lines 16, 16′ and 16″ at the conductive areas, and the insulating regions 26, 26′ are located adjacent to the gaps between the power lines 16, 16′ and 16″.

Once the apparatus 2 is located on the power line system 14, the means to draw power from the power line in the form of the pantograph 20 is actuated to draw power from the power lines 16, 16′ and 16″. Power drawn into the apparatus 2 is used to power the rotors 6,8 which contra-rotate to provide forward or reverse movement (depending of the angle of the rotor blades). The contra-rotating rotors 6 and 8 have the effect that reaction moment imported to the body is small, so that a tail rotor is not necessary. Directional and other control is achieved by varying the collective and cyclic pitch of the rotors 6 and 8. As the rotor 6, rotates the vehicle is moved forward along the power lines 16, 16′ and 16″. The pantograph 20 ensures that power is continually drawn up to power the rotors such that movement is continuous along the power line system 14.

The adjustable frames 22, 22′ are hinged so that the contact bar 23 can drag behind the apparatus 2 as shown, in FIG. 2A. The correct contact force on the contact bar is maintained by measuring the force exerted by the shaft of the linear actuator 30 and extending or retracting it as necessary, in a feedback loop, to regulate against changing apparatus 2 height. A load cell 28 is used to measure the force and the linear actuator 30 of 200 mm stroke, 25N thrust and maximum velocity 200 mms⁻¹ is used to control linkage. Measurement and actuation signals are interfaced to the digital controller 34, located in the body 4, of the apparatus 2. Power is picked up from the overhead line 16, 16′, 16″ conductor by means of the insulated HT (high tension) umbilical 36.

The pick-up bar consists of three conductive sections 24, 24′, 24″ which lie on their respective lines 16, 16′, 16″ and feed power to the apparatus 2 through the HT umbilicals 36. The three sections 24, 24′ 24″ are mechanically joined by compliant insulating sleeves 26, 26′ so that downward pressure exerted by the pantograph 20 maintains good contact between each section 24, 24′, 24″ and its power line 16,16′, 16″ despite small differences which may exist in the vertical spacing of the lines.

As the apparatus 2 moves forward along the power line system 14, the surveillance cameras 12 at the front of the apparatus body 4 continuously monitor the state of the power lines 16, 16′ and 16″ in front of the apparatus 2 and transmit signals to a remote receiver for interpretation and dissemination by an operator.

The apparatus 2 continues to travel along the power lines 16, 16 and 16″ until an obstacle is detected in the path of the apparatus by the surveillance cameras 12 (which also function as a path obstacle sensor). In FIG. 1, the power lines include insulators 18, 18′ and 18″ which extend circumventially around the power lines 16,16′ and 16′.

When the apparatus 2 travels adjacent to the insulators 18,18′ and 18″, the surveillance cameras 12 detect the insulators and send signals to a remote operator (not is shown). The remote operator can then instruct the apparatus 2 to cease drawing power from the power lines 16, 16′ and 16″ by retracting the pantograph from the power lines 16,16′ and 16′ or by simply terminating actuation of the pantograph. During locomotion along the power lines 16, 16′ and 16′, and drawing of power there from, the battery within the apparatus body 4 is charged. When power take-up is terminated, the battery may be effected to provide power to the rotors 6,8.

When power uptake is terminated by the pantograph 20, an operator may effect supply of power from the battery (not shown) to the rotors 6,8 and manipulate the angle of the rotors such that the rotors rotate at sufficient speed and angle to lift the apparatus 2 from the power supply system 14. Thus the battery and rotors 6, 8 combine to form a flight means.

The operator may then remotely control the apparatus 2 to effect locomotion distant from but along the power lines 16, 16′ and 16″ in order to traverse the obstacles in the form of the insulators 18, 18′ and 18″. When the apparatus 2 has passed the insulators, the operator may reduce the power supply from the battery and/or manipulate the angle of the rotors in order to reduce speed of the rotors and enable the apparatus 2 to descend onto the power lines 16,16′ and 16″ after the insulators 18, 18′ and 18″.

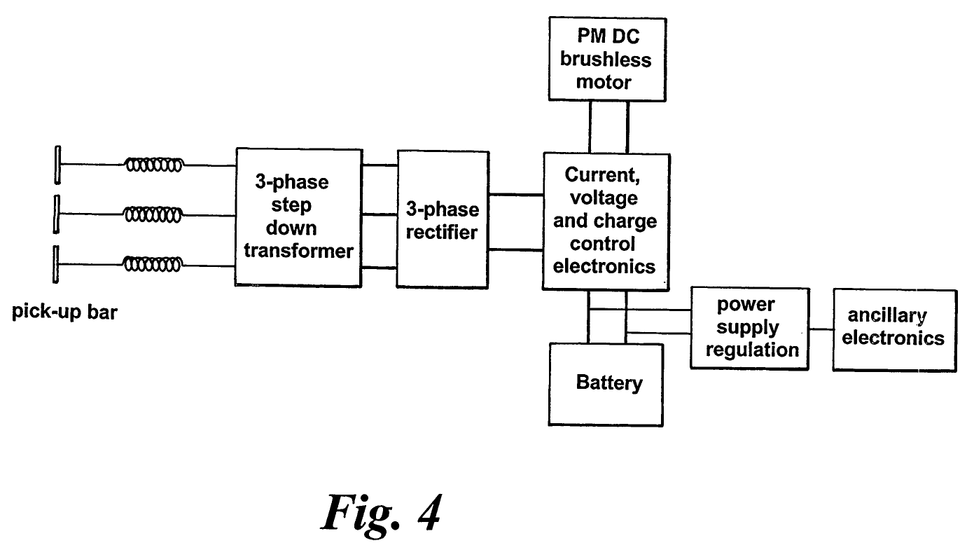

We turn now to FIG. 4, which is a block diagram of the electrical power system used to power the apparatus 2.

Power at 11 KV rms is picked up by the pantograph 20 and fed to the primary of a three phase step-down transformer and then rectified. While power is being drawn from the overhead lines 16, 16′, 16″, it is fed directly to the motor which drives the rotor blades 6, 8. A rare-earth permanent magnet D.C. brushless motor gives a high power density, typically of the order of 1 KW/Kg. The rotor blades 6, 8 are maintained at a fixed speed by regulation of the voltage and current to the motor. Charge control electronics regulates current to the battery. The power electronics used here is similar to that developed for the current generation of electrically driven automobiles. When contact with the overhead lines 16, 16′, 16″ is broken, power for the motor is drawn from the battery. The battery supplies on-board ancillary electronics at all times.

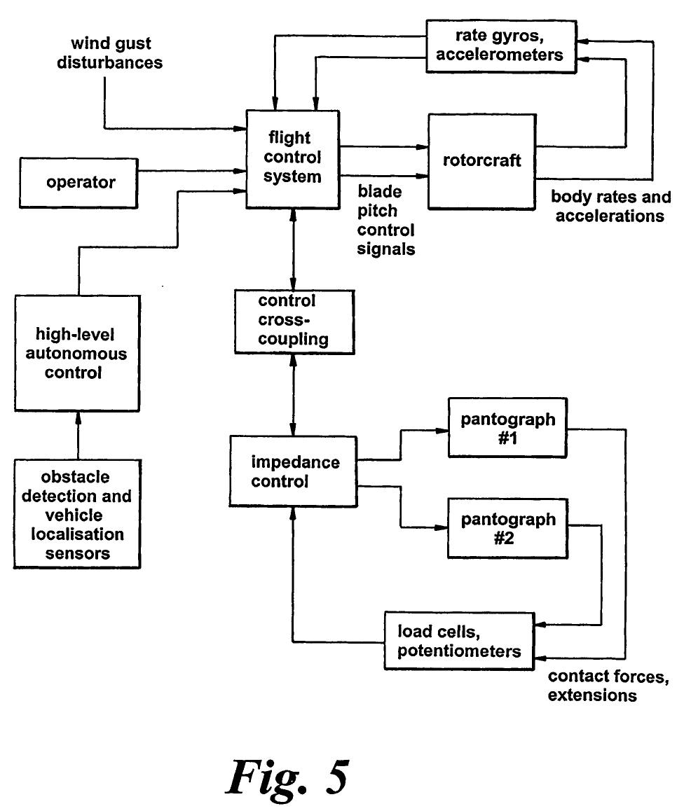

The apparatus control system, in two parts, is shown as a block diagram in FIG. 5. The upper part is the flight control system. Rate gyros (e.g. those manufactured by Humphrey Operations for UAVs) and accelerometers (e.g. supplied by Analog Devices) are used to sense the motion of the apparatus 2. The flight control system (e.g. GuideStar GS0111 by Athena Technologies) uses these signals to vary the cyclic and collective pitch of the rotor blades 6, 8 to regulate against unwanted disturbances, typically from wind gusts. The flight control system also receives demand signals from the operator with respect to mode of operation, direction and speed of flight, height etc and translates these into appropriate controls for the rotor blades 6, 8.

The lower part of FIG. 5 deals with the pantograph 20 control, which again works in a feedback mode. A load cell 28 and potentiometer (or encoder) are used to measure the contact forces and extensions of the pantograph and any errors from the demanded values are used to drive the pantograph actuators so as to maintain the contact to the overhead lines 16, 16′ 16″. The control system feedback law is based on ‘impedance control’, as developed in the field of robotic manipulators where picking up and handling fragile objects requires simultaneous control of position and force.

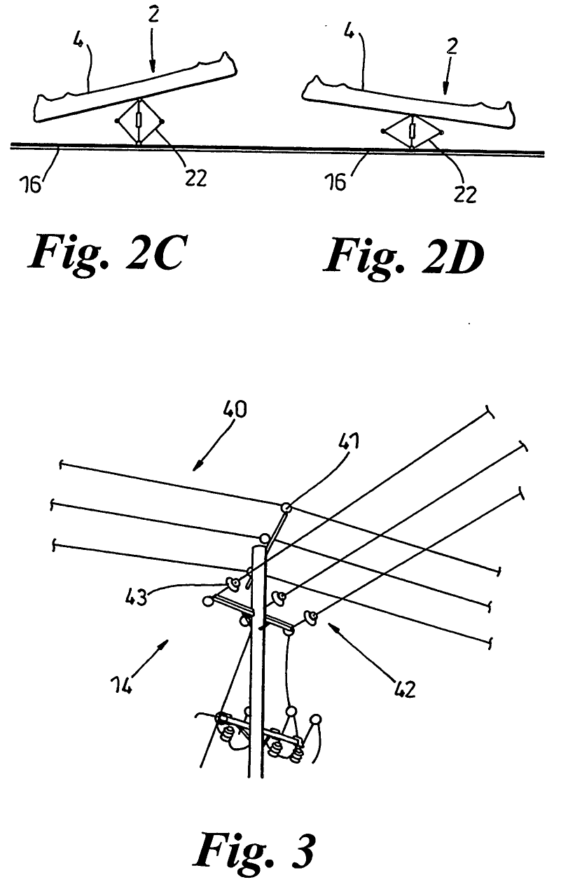

The quality of both control systems is improved by means of cross-coupling so that the flight control system is aware of the distance of the apparatus 2 from the overhead lines 16, 16′, 16″ and, in reciprocal fashion, the impedance controller is aware of the pose (i.e. the orientation and position) of the apparatus 2. On operator command, another control mode is entered where the actuators cause the pantograph to retract while manoeuvring around obstacles or changing to a branch line (such as the branch lines 42 shown in FIG. 3). There is also provision for the system to detect obstacles on the flight path and to localize the apparatus 2 with respect to the overhead line so that an alternative path may be computed, which allows it to manoeuvre around obstacles autonomously or with the minimum of operator intervention. This system comprises ultrasonic sensors and/or millimetre wave radar for range-finding and video imaging with feature detection and tracking.

The battery has sufficient power, or can recharge on the power lines 14 to perform multiply remote locomotion procedures on a given stretch of the power line system 14, such that the apparatus 2 may be arranged to remotely traverse multiple spaced apart obstacles on the power lines 16, 16′ and 16″.

The surveillance cameras 12 may be used during remote locomotion of the apparatus 2 as an apparatus orientation means, in order for an operator to determine the position, direction etc of the apparatus 2 when remote from the power lines 16,16′ and 16″.

Alternatively or additionally the apparatus 2 may comprise further apparatus orientation means such as monitors, detectors or cameras which are autonomous or operator controlled, in which may be placed anywhere on the apparatus 2 in order to determine movement, direction and the like parameters when remote from the power lines and or when located on the power lines.

When the apparatus returns to the power lines after traversing an obstacle, the pantograph 20 is actuated to recommence drawing up of power from the power lines 16, 16; and 161′, which can recharge the re-chargeable battery (not shown) in order for subsequent remote locomotion of the apparatus.

Preferably the battery or any other power source present within the apparatus body 4 has enough power to enable traversal of obstacles on the power lines 16, 16′ and 16″, but not enough power to allow the apparatus 2 to travel above a pre-determined altitude, for example 80 metres from ground level or less, and thus functions as an altitude limiting means.

This safety fall back enables the apparatus to be used in regions and jurisdictions in which regulations are in place controlling unmanned or manned vehicles and aircraft.

We turn to FIG. 3 which illustrates part of a power line system 14 which includes a main three phase power line set up 40, and perpendicular to the main power lines 40 a branch three phase power line system 42, at a lower altitude. The power lines 40 include obstacles in the form of insulators 41, and the power lines 42 also include obstacles in the form of insulators 43. The apparatus 2 of the preferred embodiment of the invention is suitable for traversing both the power line 40 and the obstacles as described herein and above, but also is suitable for remote travel between the power lines 40 and the power lines 42 such that the branch line 42 may be inspected in the same inspection period as the main lines 40. The apparatus 2 may travel along either the branch lines 42 or main lines 40 and be activated to remotely travel to the other of the main lines 40 or branch lines 42 by remote flight as described hereinabove and with suitable control of direction by the operator of the apparatus 2.

When it is desired to stop monitoring of the power line system 14, the apparatus is actuated to terminate power drawn from the power lines 16, 16′ and 16″ as described above, and the apparatus is then effected to undergo remote locomotion from the power lines down to ground level by suitable input of signals transmitted by the remote user.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A power line inspection apparatus comprising a vehicle body to which is mounted a power line traversal means, a power line inspection means and means to draw power from a power line to which it is attached, in use.

2. A power line inspection apparatus as claimed in claim 1 wherein the power line traversal means comprise a locomotion means arranged in use to effect locomotion of the apparatus on or in the region of the power lines to which it is mounted.

3. A power line inspection apparatus as claimed in claim 1 wherein the locomotion means comprises at least one rotor.

4. A power line inspection apparatus as claimed in claim 3 comprising at least two contra-rotating rotors.

5. A power line inspection apparatus as claimed in claim 4 wherein the contra-rotating rotors are superposed.

6. A power line inspection apparatus as claimed in claim 4 wherein the contra-rotating rotors are in a ducted fan or shrouded fan configuration.

7. A power line inspection apparatus as claimed in claim 1 wherein the power line inspection means comprises a camera.

8. A power line inspection apparatus as claimed claim 1 wherein the power line inspection means comprises one or more power line characteristic sensors.

9. A power line inspection apparatus as claimed in claim 8 wherein the or each power line characteristic sensor is selected from the group consisting of a current sensor, a voltage sensor, a power line dimension sensor, a power line topology sensor, a thermal sensor, and a corona discharge sensor.

10. A power line inspection apparatus as claimed in claim 1 wherein the means to draw power from the or each power line comprises means to induce current from the power line.

11. A power line inspection apparatus as claimed in claim 1 wherein the means to draw power from the power line comprises an ohmic contact means.

12. A power line inspection apparatus as claimed in claim 11 wherein the ohmic contact means comprises a pantograph.

13. A power line inspection apparatus as claimed in claim 12 wherein the pantograph comprises means to bias the pantograph onto the or each power line, when the apparatus is mounted to the or each power line.

14. A power line inspection apparatus as claimed in claim 13 wherein the biasing means comprises a resilient biasing means.

15. A power line inspection apparatus as claimed in claim 13 wherein the biasing means comprises an actuator or servo, comprising force and position transducers which monitor the force and position of the pantograph actuator or servo and effects adjustment of the pantograph in response.

16. A power line inspection apparatus as claimed in claim 1 further comprising means to circumnavigate obstacles on or in the region of the power lines, in use.

17. A power line inspection apparatus as claimed in claim 1 further comprising flight means or remote travel means.

18. A power line inspection apparatus as claimed in claim 17 wherein the remote travel means comprises means able to effect hovering or flight of the apparatus above a power line.

19. A power line inspection apparatus as claimed in claim 17 wherein the remote travel means comprises the power line locomotion means.

20. A power line inspection apparatus as claimed in claim 1 wherein the apparatus comprises means to effect cessation of power take-up from a power line.

21. A power line inspection apparatus as claimed in claim 1 further comprising a power storage means.

22. A power line inspection apparatus as claimed in claim 21 wherein the power storage means comprises a power cell or battery.

23. A power line inspection apparatus as claimed in claim 22 wherein the power cell or battery comprises means to recharge via uptake from a power line to which the apparatus is attached, in use.

24. A power line inspection apparatus as claimed in claim 1 further comprising a path obstacle sensor, arranged in use to detect obstacles in the path of the apparatus, on or in the vicinity of a power line.

25. A power line inspection apparatus as claimed in claim 1 further comprising an apparatus orientation means, which comprises means for the apparatus to detect its orientation with respect to a power line.

26. A power line inspection apparatus as claimed in claim 1 further comprising movement adjustment means, arranged in use to adjust the movement of the apparatus when an obstacle is detected on the power line in the vicinity of the apparatus.

27. A power line inspection apparatus as claimed in claim 1 further comprising altitude limiting means, arranged in use to limit the altitude to which the apparatus can ascend remote from the or each power line which it is designed to inspect.
